(19) United States
(12) Patent Application Publication
(10) Pub. No.: US 2008/0280589 A1
(43) Pub. Date: Nov. 13, 2008

(54) Wireless Device with Billing Code Button

(75) Inventors: Jonathan Cowper, San Antonio, TX (US); Benjamin Kryczka, San Antonio, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: AT&T KNOWLEDGE VENTURES, LP, Reno, NV (US)

(21) Appl. No.: 11/745,731

(22) Filed: May 8, 2007

(51) Int. Cl. H04M 1/00

(52) U.S. Cl. 455/406; 455/418; 455/419

(57) ABSTRACT

A wireless communication device comprises a button depressable to associate a communication with the device with a billing account. A method is also disclosed of assigning a communication with a wireless device to a billing account. The method comprises receiving a code from the wireless device corresponding to the billing account, and associating the communication with a billing account.

### FIELD OF THE DISCLOSURE

The present disclosure generally relates to telecommunications, and more particularly relates to assigning billing codes for wireless device usage.

### BACKGROUND

Mobile telephone usage has become increasingly ubiquitous and an essential part of both the personal and professional lives of many users. Unfortunately, individuals who rely on wireless handset technology for both their personal and professional lives often face a recurring accounting problem. While many businesses want their employees to have wireless telephones, many of those same businesses require their users to ensure that the business is not paying for personal telephone usage.

As such, some users are asked to certify that they will not make personal calls with business phones. Users may also be required to pay their monthly bill and to submit a reimbursement request—including a copy of the bill with reimbursable business calls clearly identified. These techniques often waste both time and money. And, while these techniques may be moderately effective, they include several weaknesses.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a functional block diagram illustrating a hardware environment for placing a telephone call in accordance with an exemplary embodiment of the present invention;

FIG. 2 is a schematic diagram of a wireless device having billing code buttons in accordance with an exemplary embodiment of the present invention; and

FIG. 3 is a flow chart of a method of assigning communications with a wireless device to a billing account.

The use of the same reference symbols in different drawings indicates similar or identical items.

### DETAILED DESCRIPTION OF THE DRAWINGS

Embodiments discussed below describe, in part, approaches for allowing wireless service subscribers to apply different account codes to their respective services. The following discussion focuses, primarily, on an individual user or subscriber based service. The teachings disclosed herein, however, may also be used to provide multiple wireless account management services to groups, enterprises, and/or companies. From a high level, a user may have a single wireless enabled device that is used for both business and personal purposes. As such, the user may want a relatively easy way to distinguish between business and personal calls—whether those calls are placed calls or received calls. In some cases, a user may be employed as a contractor or professional service provider supporting multiple clients at the same time. One or more of these clients may be willing to reimburse the user for cellular costs incurred in connection with providing the client with service. The user may be able to make use of the teachings disclosed herein to facilitate the management of his or her multiple wireless sub-accounts.

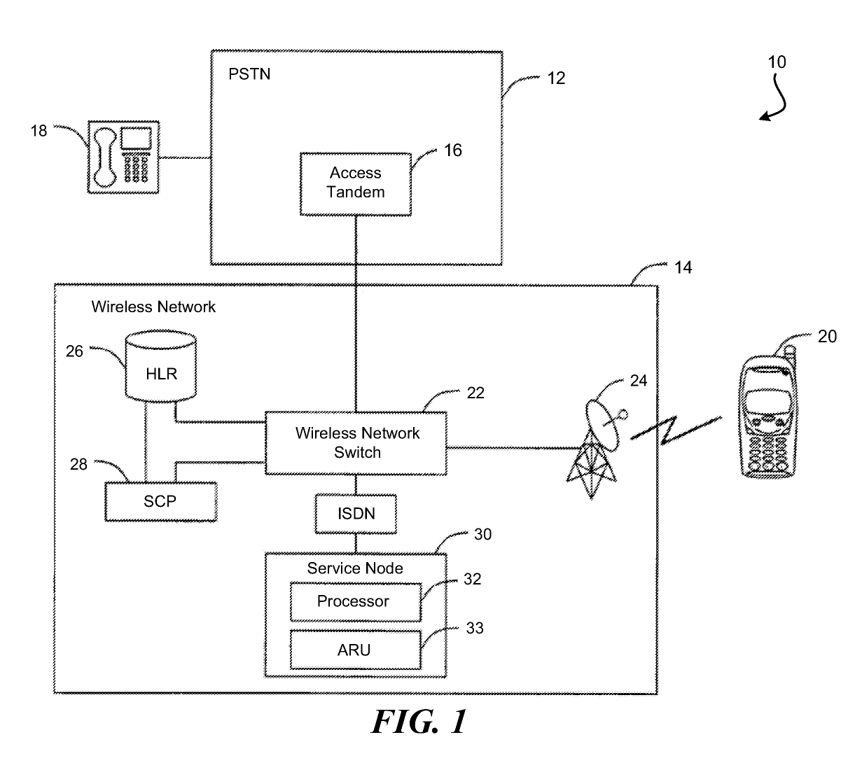

FIG. 1 shows a telecommunication system hardware environment 10 for cellular and Personal Communication Systems including a public switched telephone network (PSTN) 12 and a wireless network 14. The PSTN 12 contains Advanced Intelligence Network (AIN) elements of a typical local exchange carrier. The PSTN 12 may be viewed as the aggregate of all lines and equipment serving to connect telephone users, but excludes private networks formed from leased telephone lines, wireless systems, and public data networks like the Internet. The terminating equipment in the wireless network 14 is “wireless” in the sense that the equipment is not connected by any lines or wires to network elements. The terminating equipment in the wireless network 14 (referred to herein as “wireless units”) receive communications through radio signals rather than through wire or fiber optics. A cellular telephone network is an example of a wireless network 14. Thus, a “wireless unit” is generalized to include a cellular telephone, a mobile telephone, a mobile station, a portable telephone, and other devices that receive communications through radio signals rather than through wire or fiber optics.

The PSTN 12 is connected to the wireless network 14 through an access tandem 16. The connection of the PSTN 12 to the wireless network 14 through the access tandem 16 (or similar network element) allows for the interconnection of these two communication systems. Such interconnection is necessary so that a call from a wireline unit, such as a landline telephone 18, may be connected to a wireless communications device, such as a wireless telephone 20 or a personal digital assistant (PDA). Also, the wireless network 14 typically includes a geographic radio service area divided into cells. Each cell is normally serviced by a broadcast antenna 24 that permits communication between a wireless unit 20 operating within the area of the cell, and a cell control (also known as a base station). The cell control, in turn, is connected to a wireless network switch or Mobile Switching Center (MSC) 22. The wireless network switch 22 communicates with the cell control either through dedicated telephone facilities, or more frequently, through a cell-to-mobile switching center data link disposed between the cell control and the wireless network switch 22.

Generally, the wireless network switch 22 keeps up with the location of wireless units 20 that are deemed to be associated with that particular switch 22, such that the switch 22 is able to provide information with respect to the location and/or availability of any particular wireless unit 20. More specifically stated, the active status and/or availability of a wireless unit 20 in a particular area is typically made known to the relevant wireless network switch 22 as a result of a communication process between the wireless unit 20 and the cell control. The process is commonly known in the art as registration. Once a wireless unit 20 registers within a geographic area served by a wireless network switch 22, the switch 22 receives the registration information from the cell control and stores the pertinent information in a register, such as a Home Location Register (HLR) 26. If a wireless unit 20 is associated with a subscriber of that particular wireless network 14, then the registration information is stored in the HLR. In other words, the wireless unit 20 is considered to be operating within its home territory. On the other hand, if the wireless unit 20 is not associated with a subscriber of that particular wireless network, then the registration information may be stored in a Visitors' Location Register (VLR). In other words, the subscriber unit 20 is considered to be a visitor to the geographic area serviced by the wireless network switch 22. If necessary, the pertinent information relating to a particular wireless unit 20 is passed through the wireless network 14 to the wireless network switch 22 that is deemed to be the “home” switch of a particular unit 20. The HLR 26 and the Visitors' Location Register (VLR) are used by the wireless network 14 in any of several different manners, well known to those skilled in the art, to work with the PSTN 12 in the routing of communications to and from subscriber units 20 and through the PSTN 12. The home location register 26 is connected by a data link that uses wireless network protocols well known to those skilled in the art, to a Service Control Point (SCP) 28 in the PSTN 12. Through the data link, the SCP 28 checks with the wireless network 14 with respect to the activity and/or availability of a particular wireless unit 20 operating within the area served by the wireless network 14.

A telecommunications element referred to as a service node 30 may be physically implemented by the same types of computers that embody the SCP 28. In addition to computing capability and database maintenance features, the service node 30 may also include switching fabric, voice and Dual Tone Multiple Frequency (DTMF) signal recognition devices, and voice synthesis devices. The service node 30 is typically connected to one or more switches via an Integrated Services Digital Network (ISDN) link 29 that provides Primary Rate Interface (PRI) and Basic Rate Interface (BRI) interfaces for voice and data channels between the service node 30 and the PSTN 12. The service node 30 may also comprise a conference bridge and a service node control computer. The conference bridge may comprise a switch for “bridging” or connecting conference participants. The service node control computer executes software for assigning communications with the wireless device 20 to a billing account.

The service node 30 includes a processor 32 that provides intelligent application processing for the switch 22. Certain functionality that may be performed by the switch 22 is off-loaded to the service node 30 to enable the switch 22 to focus on performing switching and queuing functionality. The service node 30 includes an Automated Response Unit (ARU) 33 that provides voice response and menu routing functions to a subscriber. The ARU 33 facilitates caller input via selection of dual tone multi-frequency (DTMF) digits, such as by pressing keys on a telephone keypad. The ARU 33 provides various automated menus which the caller may navigate through in order to program a desired service. The ARU 33 includes a network audio server which is a server computer that has a voice telephony interface to the service node 30. The audio server is linked to the service node 30 via multiple voice trunks and, in general, provides an audio interface to a subscriber. The ARU 33 also includes an automated call processor that provides intelligent call processing functions for the ARU 33. The ARU 33 is responsible for handling all initial inbound calls for the platform. The automated call processor operates by executing scripts that take subscribers through a series of menus, accept caller input, make decisions based upon caller input, and perform actions such as the transfer of a call to another destination to provide appropriate provisioning services. The automated call processor prompts the audio processor to play prompts to subscribers, to gather DTMF digit input, to play various recorded messages, and to direct the subscriber to other destinations if necessary. Further details of the system 10 are taught in U.S. Pat. No. 7,133,665, the disclosure of which is hereby incorporated by reference.

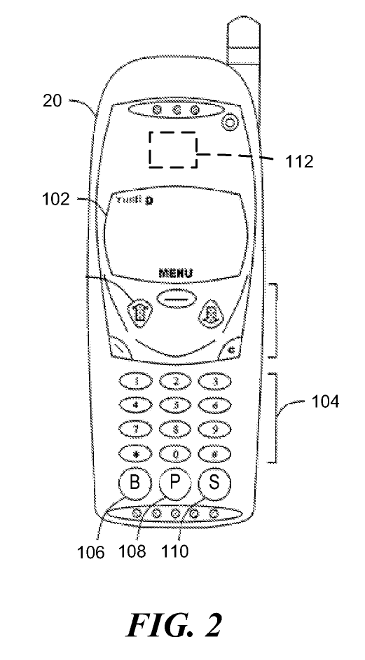

FIG. 2 shows the wireless unit 20 such as a cellular telephone having a display 102, an alphanumeric keypad 104, and billing account code buttons 106, 108 and 110. As is well known, the cellular telephone 20 includes hardware operable for sending and receiving telephonic signals. In general, the buttons 106, 108 and 110 correspond to different accounts that a user of the cellular telephone 20 wishes to track. For example, the button 106 may designate an incoming or outgoing call as business-related, the button 108 may designate the call as personal-related, and the button 110 may assign accounting for the call to a subaccount for specific clients or projects. It should be appreciated, of course, that the buttons 106, 108 and 110 may be pre-set by the manufacturer or distributor of the device 20, or softkeys programmable by the user or by the service provider over the network.

In a preferred embodiment, the telephone 20 in a default state assigns all incoming or outgoing calls to a personal account. However, the user may depress the button 106, either immediately prior to or during the call, to associate accounting of that call with a general business account. In the same way, the user may depress the button 110 either before or during placement to scroll through a list of business subaccounts to which the call may be assigned. Upon depression of one of the buttons 106, 108 or 110, the device 20 sends a signal back to the switch 22 informing the wireless network 14 that it should account for the then current call in the indicated manner. The creation and maintenance of billing account codes suitable for use with the present invention is further described in U.S. Patent Application publication no. 2006/0019630, the disclosure of which is hereby incorporated by reference. In this way, the device 20 allows a provider of cellular service to generate monthly invoices with call detail records broken out for ease of review by the user.

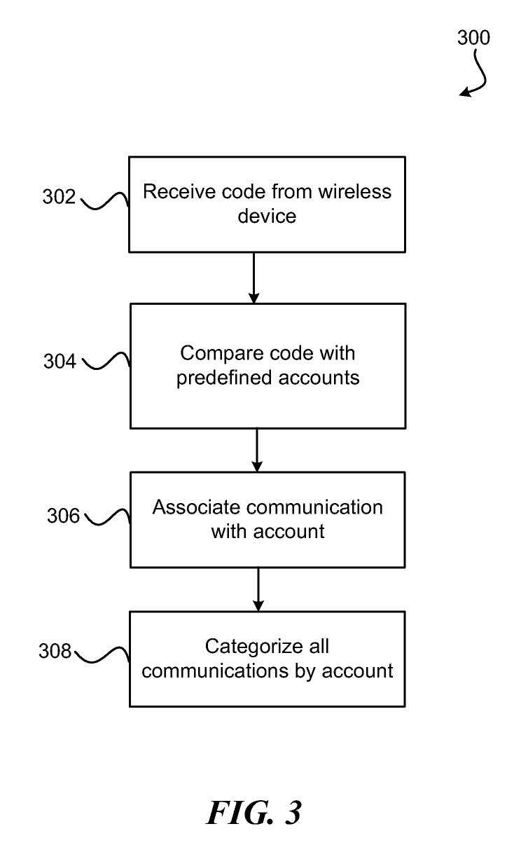

FIG. 3 shows a flow chart of a method 300 for tracking telephone calls to or from a wireless communication device. At block 302, a provider of service to the wireless device receives a DTMF or other code from the device. The code is then compared, at block 304, with accounts previously defined by the provider or user, such as a general business account, particular business subaccounts, or a personal account. At block 306, the contemporaneous communication, or the one nearest in time, is associated with the account matched in block 304. At the end of the reporting period, the method categorizes all communications occurring during that period according to the various accounts, as indicated at block 308.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A wireless communication device comprising:
a button depressable to associate a communication with the device with a billing account.

2. The wireless communication device of claim 1 wherein the communication is incoming to the device.

3. The wireless communication device of claim 1 wherein the communication is outgoing from the device.

4. The wireless communication device of claim 1 wherein the communication is a telephone call.

5. The wireless communication device of claim 1 wherein the billing account is associated with business usage.

6. The wireless communication device of claim 1 wherein the billing account is associated with personal usage.

7. The wireless communication device of claim 1 wherein the communication is a data communication.

8. A telecommunications system comprising:
a wireless device having a button; and
a service node in communication with the wireless device, the service node associating a communication with the wireless device with a billing account upon depression of the button.

9. The telecommunications system of claim 8 wherein the communication is incoming to the wireless device.

10. The telecommunications system of claim 8 wherein the communication is outgoing from the wireless device.

11. The telecommunications system of claim 8 wherein the communication is a telephone call.

12. The telecommunications system of claim 8 wherein the billing account is associated with business usage.

13. The telecommunications system of claim 8 wherein the billing account is associated with personal usage.

14. A method of assigning a communication with a wireless device to a billing account, the method comprising:
receiving a code from the wireless device corresponding to the billing account; and
associating the communication with a billing account.

15. The method of claim 14 wherein the code is generated by depressing a button of the wireless device.

16. The method of claim 14 wherein the communication is incoming to the device.

17. The method of claim 14 wherein the communication is outgoing from the device.

18. The method of claim 14 wherein the communication is a telephone call.

19. The method of claim 14 wherein the billing account is associated with business usage.

20. The method of claim 14 wherein the billing account is associated with personal usage.
